(19) United States
(12) Patent Application Publication
(10) Pub. No.: US 2010/0330327 A1
(43) Pub. Date: Dec. 30, 2010

(54) Carpet tiles and methods of producing carpet tiles with diversity of color and texture

(75) Inventors: David D. Oakey, Atlanta, GA (US); Bridget Machell, West Point, GA (US)

Correspondence Address: JOHN S. PRATT, ESQ;KILPATRICK STOCKTON, LLP, 1100 PEACHTREE STREET, SUITE 2800, ATLANTA, GA, 30309, US

(73) Assignee: Interface, Inc., Atlanta, GA (US)

(21) Appl. No.: 12/802,783

(22) Filed: Jun. 14, 2010

Related U.S. Application Data
(60) Provisional application No. 61/268,432, filed on Jun. 12, 2009.

(51) Int. Cl. D05C 17/02; B32B 3/02

(52) U.S. Cl. 428/89; 428/85

(57) ABSTRACT

Embodiments of the invention provide carpet tile patterns and techniques for making carpet tile patterns that provide diversity of color, texture, and/or other pattern attributes. In some embodiments, a color attribute changes along a dimension of a web from which the carpet tiles are cut. In other embodiments, a yarn pile height changes along a dimension of a web from which the carpet tiles are cut. In some embodiments, carpet tiles mimic in some respects the appearance of wood flooring having natural variations in the appearance of the wood elements.

### RELATED APPLICATION DATA

The present application claims priority to U.S. Provisional Application No. 61/268,432, filed Jun. 12, 2009, entitled “CARPET TILES AND METHODS OF PRODUCING CARPET TILES WITH DIVERSITY OF COLOR AND TEXTURE,” the contents of which are herein incorporated by reference.

### FIELD OF THE INVENTION

This disclosure relates generally to carpet tiles and other textile face modular flooring and to methods of designing modular flooring tiles having patterns and color schemes that provide various aesthetic and functional benefits.

### BACKGROUND

Interior design is endlessly emulative and self-referential. Design elements often copy or emulate other materials or structures, and innovative materials and components often pursue acceptance through stealth, by mimicking that which is conventional and accepted.

When commercial carpet tile was introduced, it sought to hide its modularity and provide the appearance of broadloom carpet, which looks continuous. The imperative of a broadloom-like, continuous appearance long dictated that carpet tile styles be uniform in color and pattern within tiles and from one tile to another. This tended to dictate that design elements be relatively small. Because of challenges associated with tile manufacture, some tile makers sought to achieve uniformity by manufacturing monochromatic tile and then printing further pattern elements on the face of the tile after it had been produced and the locations of the edges established. Careful installation was required with all of the tiles “facing” in the same direction, as the tiles had been during manufacture. The quest for broadloom-like appearance without all of the traditional carpet tile constraints met new solutions with the inventions described in U.S. Pat. No. 6,908,656 (entitled “Orthogonally ambiguous carpet tile,” filed Feb. 14, 2001) and U.S. Pat. No. 7,083,841 (entitled “Orthogonally ambiguous carpet tiles having curved elements,” filed Jun. 7, 2002), both to David Oakey and Sydney Daniel, and both of which are incorporated herein in their entireties by this reference. Among other things, these patents teach using a pattern on each carpet tile of a carpet tile style that appears random, and then randomly orienting those carpet tiles in an installation to create a larger, apparently random pattern, in which tiles do not look out of place. While the color pattern on the carpet tiles described in these patents have random-looking elements and varied somewhat from one tile to another, significant other aspects of the tiles were very consistent across tiles and from tile to tile.

Carpet tile designers are also now designing patterns to emphasize, rather than hide, the modularity of the carpet tiles. Such carpet tiles are often installed “quarter-turned” with each carpet tile position rotated 90 degrees relative to each adjacent tile.

Released from the constraint that modularity should be hidden, conventional elements of design long eschewed by carpet tile have become available for inspiration, such as ceramic tile, and various types of wood flooring, including strip and parquet wood flooring.

For many conventional carpet tile designs, the nature of the design requires that carpet tiles in a particular installation all use yarn dyed in the same dye lot to avoid visually discernable differences between adjacent carpet tiles resulting from variations in dying. This has presented various problems with respect to installation of new carpet tile and replacing soiled or damaged carpet tiles in an installation.

Generally, existing design and manufacturing techniques could be improved to satisfy better the desire to emulate and base carpet tile designs on new sources of inspiration, like wood flooring, the continuing issues related to dye lots, and the desire for increased randomness or diversity of tile color and/or other pattern attributes.

### SUMMARY

The present disclosure provides new carpet tile patterns and techniques for making carpet tile patterns that provide diversity of color, texture, and/or other pattern attributes. Such diversity can provide one or more of a variety of aesthetic benefits, including but not limited to, improved hiding of seams within a tile installation, improved merge-ability of yarn color dye lots, improved ability to replace used or soiled carpet tiles, easier carpet tile installation, and/or improved ability to mimic natural elements, such as wood, that naturally include a significant amount of diversity. In particular, tile installations of certain embodiments of this invention mimic in some respects the appearance of wood parquet flooring having natural variations in the appearance of the wood elements.

Exemplary embodiments described here provide a carpet tile style (groups of tiles manufactured and sold for installation together) in which carpet tiles of the style include differing amounts of the colors used. For example, some carpet tiles may include more light colors and other carpet tiles may include more dark colors than one another. Similarly, another exemplary embodiment provides a carpet tile style in which carpet tiles include differing amounts of texture. For example, tufts of two, three, four or more different pile heights may be used in the style. In some embodiments, carpet tile is produced by tufting to form a web and pile height is varied down the length of the web. As a specific example, there may be a first portion having lower tufts than the next portion of the web such that one tile will have lower tufts than the next. In one embodiment, the web pattern is varied both with respect to color, e.g., across its width, and with respect to texture, e.g., down its length, creating tiles with various combinations of color and texture. The aesthetic of a given carpet tile style may be enhanced or changed by alternatively, or in addition, including diversity of other pattern attributes.

These exemplary embodiments are mentioned not to limit or define the disclosure, but to provide examples of embodiments to aid understanding thereof. Embodiments are discussed in the Detailed Description, and further description is provided there. Advantages offered by the various embodiments may be further understood by examining this specification.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

A full and enabling disclosure including the best mode of practicing the appended claims and directed to one of ordinary skill in the art is set forth more particularly in the remainder of the specification. The specification makes reference to the following appended figures, in which use of like reference numerals in different figures is intended to illustrate like or analogous components.

FIGS. 1A-1B are top plan views illustrating certain color features of an exemplary carpet tile web pattern.

FIG. 2 is a top plan view illustrating certain texture features of the exemplary carpet tile web pattern of FIGS. 1A-1B.

FIG. 3 is an image of a quarter-turned installation of carpet tiles produced with diverse colors and texture according to one embodiment of the invention.

FIG. 4 is an image of another quarter-turned installation of carpet tiles produced with diverse color and texture according to another embodiment of the invention.

FIG. 5 is an image of another installation of carpet tiles produced with diverse color and texture according to another embodiment of the invention.

FIGS. 6A-6H are images of another installation of carpet tiles produced with diverse color and texture according to other embodiments of the invention.

### DETAILED DESCRIPTION

This invention provides new carpet tile patterns and techniques for designing and manufacturing carpet tile with diversity of color, texture, and/or other pattern attributes. Such diversity can provide one or more of a variety of aesthetic and functional benefits. Certain exemplary embodiments provide a carpet tile style in which carpet tiles of the style include differing amounts of the style's colors. For example, a carpet tile style may utilize six colors. The use of those colors (e.g., the percentage of each yarn color present) can vary among tiles of the style. For example, if a first three of the six colors are lighter than a second three of the six colors, certain tiles may include more of the first three colors while other tiles include more of the second three colors. Similarly, in a carpet tile style, carpet tiles may include differing amounts of texture. For example, a style may include four different pile heights: lowest, low, medium, and high. Some tiles may include tufts of the lowest and low heights and other may include tufts of the lowest and high heights, etc. Various combinations of the four pile heights may be present in the different tiles and may vary through a given tile.

One method of producing such a pattern involves using a tufting machine to tuft a web having a pattern of color and texture, in which the use of color and texture vary across and/or along the web pattern. Commercial carpet tiles may be manufactured utilizing a number of techniques, but the substantial majority of such products are manufactured by tufting carpet yarns into a tufting primary using a tufting machine. The fabric produced by the tufting machine is usually about six feet or two meters wide, and that fabric is referred to here as a carpet tile “web.” After the web is produced, secondary backing layers are bonded to its underside to provide stability, stiffness, weight and other desirable properties, and the backed web is then cut into tiles. Those tiles are usually eighteen inches or one-half square meter, so that a row of four tiles are usually cut across the backed web.

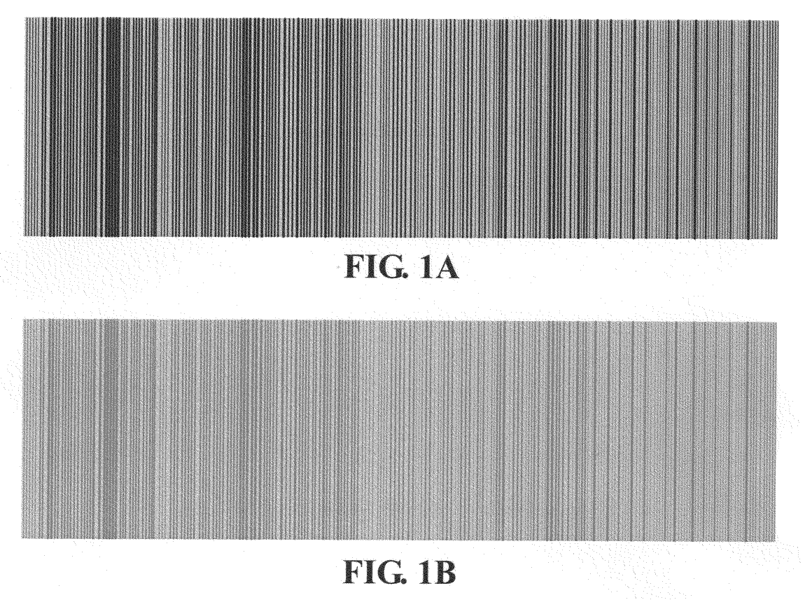

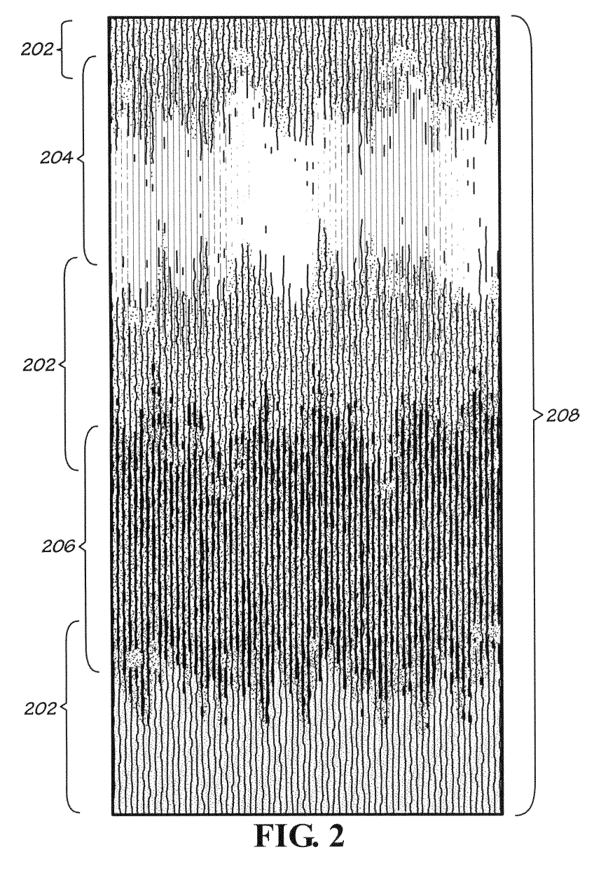

FIGS. 1A-1B are top plan views illustrating certain color features of an exemplary carpet tile web. Such a carpet tile web can be made, for example, using a cut and loop tufting machine. FIG. 1A illustrates the varied use of three colors across a cut portion of a web pattern. Each of the colors shown in FIG. 1A represents a yarn color, which may in fact have one or more colors in it, e.g., a single color yarn, a barber pole yarn, a heathered yarn, etc. Generally, however, the color of each yarn will have a color attribute, such as lightness or darkness, which will differ with respect to the other yarn colors used in the web color pattern. In FIG. 1A, the colors represent that more darker yarns are present in the left portions of the web pattern and more lighter yarns are present in the right portions of the pattern. In this exemplary case, the amount of light and dark yarn gradually changes across the web pattern. In other embodiments, the amount of light and dark yarns (or other color attribute that is being varied) can change abruptly across the web color pattern. In still other embodiments, the color attribute may change and then change back one or more times across the web pattern. Generally, however, the yarn color attribute is varied such that the tiles cut from the different tile positions across the web pattern have differences with respect to the color attribute. In the example of FIG. 1A, tiles cut from the left portion of the web will have more darker yarn present and tiles cut from the right portion of the web will have more lighter yarn present. Alternative arrangement are, of course, possible.

FIG. 1B illustrates the varied use of three colors across a loop portion of the web color pattern. In patterns using both a cut portion and a loop portion, a color attribute can be varied across one or both portions by, as illustrated in the present examples, controlling the thread-up of that portion. Each of the colors shown in FIG. 1B represents a yarn color, which may in fact have one or more colors in it, e.g., a single color yarn, a barber pole yarn, a heathered yarn, etc. Generally, however, the color of each yarn will have a color attribute, such as lightness or darkness, which will differ with respect to the other yarn colors used in the web color pattern. In FIG. 1B, as in FIG. 1A, the colors represent that more of the darker yarns are present in the left portions of the web pattern and more of the lighter yarns are present in the right portions of the pattern. Exemplary color attributes include value, hue, saturation, among others known and used by carpet tile design and manufacturers.

Alternative embodiments may, of course, implement differences in pattern color attributes in alternative ways than discussed in the previous examples. For example, a carpet web may be produced with a pattern using other types of tufting machines. As another example, use of color may be varied alternatively, or in addition, along the length of a tufting machine. Additionally, two or more separate carpet webs may be used to produce carpet tiles of a single style. In such a style, as an example, one machine web color pattern may include more darker yarns and the other machine's web color pattern may include more lighter yarns. Carpet tile patterns may also be formed by printing, weaving, or otherwise.

FIG. 2 is a top plan view illustrating certain texture features of the exemplary carpet tile web of FIGS. 1A-1B. In this exemplary embodiment, texture differences are implemented by varying the yarn pile height pattern along the length of the web. FIG. 2 represents a tuft-height web pattern repeat that is approximately four carpet tiles wide and eight carpet tiles long. The tuft-height web pattern repeats lengthwise, i.e., a tufting machine may begin tufting at the top of the tuft-height web pattern shown in FIG. 2 and, upon reaching the bottom, begin again from the top without breaking the tufted web to thus produce a web that is longer than the pattern shown in FIG. 2, but in which the tuft-height web pattern shown in FIG. 2 is repeated along that length. Carpet tiles cut from such a web may vary with respect to their relative position along the length of such a web, i.e., the pattern repeat length may not correspond to an integer multiple of the carpet tile length. This variability can further enhance the variability of texture in the resulting carpet tiles.

In FIG. 2, the different colors represent different pile heights for the yarns to be tufted. In this exemplary embodiment, there are four pile heights—one corresponding to each of the figure colors. Here, the white color illustrates the lowest pile height, e.g., 0.310 cm which, in this example, is used for all of the cut yarns (i.e., those whose color is defined by the web color pattern of FIG. 1A). The three other colors (light, medium, and dark) are used to represent the pile heights of the yarns of the loop yarns, i.e., those whose yarn color is defined by the web color pattern of FIG. 1B). In FIG. 2, the light color represents a low pile height (e.g., 0.550 cm), the medium color represents a medium pile height (e.g., 0.600 cm), and the dark color represents a high pile height (e.g., 0.700 cm).

In FIG. 2, the amount of the lowest, low, medium, and high pile heights varies along the length of the web. The lowest pile height (i.e., represented by white) is present along the entire length 208 of the web tuft-height pattern repeat. However, the low pile height is used only in portion 204, the medium pile height is used only in portions 202, and the high pile height is used only in portions 206. These portions 202, 204, 206 may be positioned and/or sized so that at least some of the carpet tiles cut from a resulting web will comprise only one of the low, medium, and high pile heights. These portions may be positioned and/or sized to avoid significant pile height differences in some or all of a pattern so that a carpet tile cut from the web will not, for example, have loop tufts that are both low and high. Avoiding such extreme differences can help soften the appearance of the tiles and avoid, to the extent it is unwanted, the appearance of horizontal lines. The positions, sizes, and/or arrangement of the different pile heights in a given design can, of course, be modified for additional functional and aesthetic reasons as well.

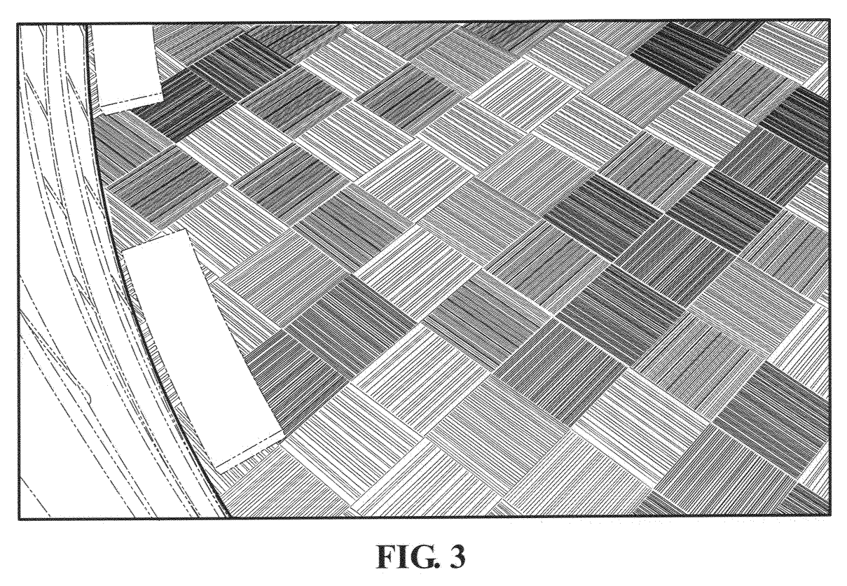

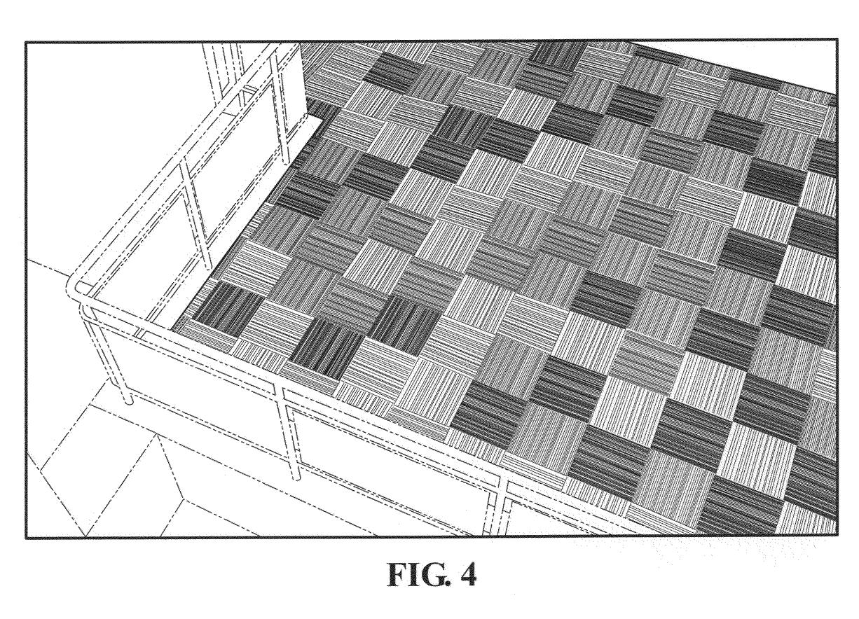

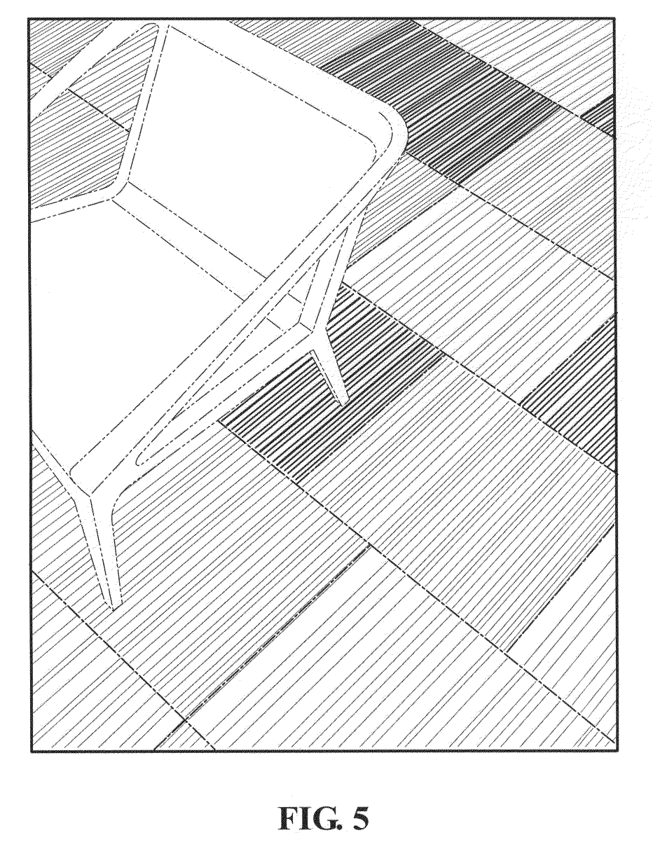

FIGS. 3-5 are images of quarter-turned installations of carpet tiles produced with diversity of color and texture according to other embodiments.

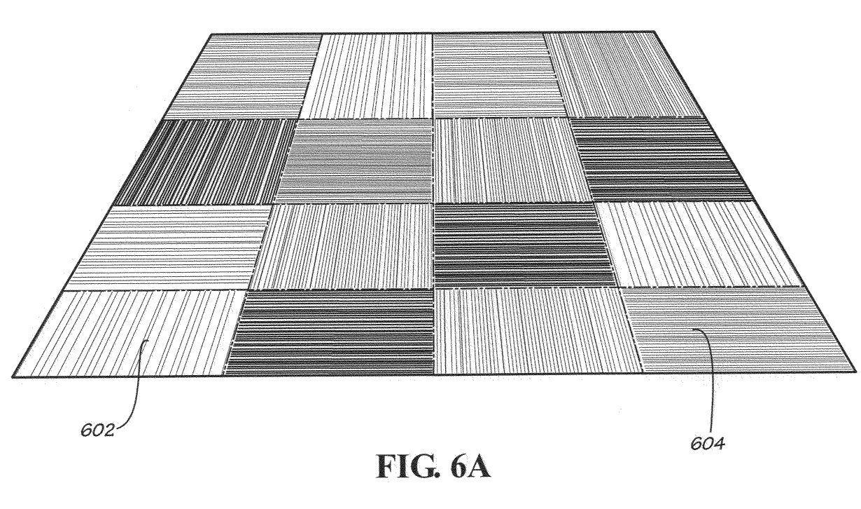

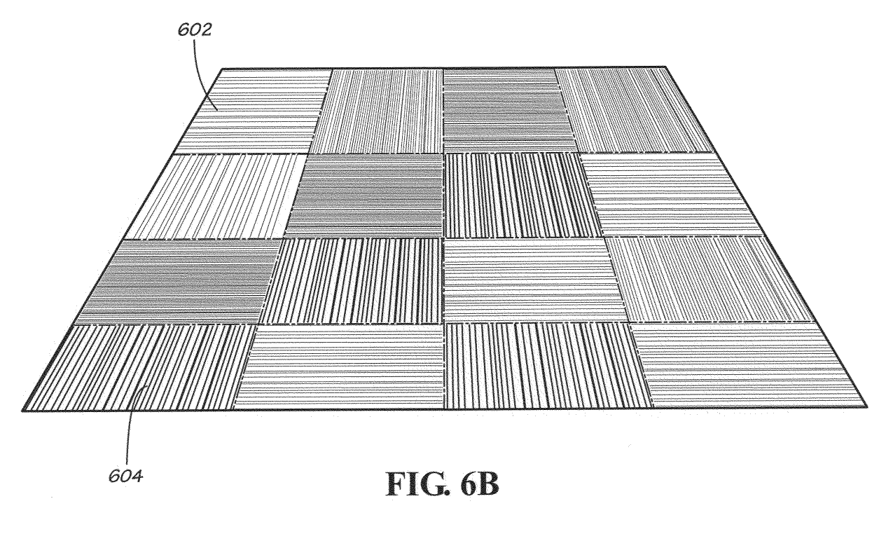

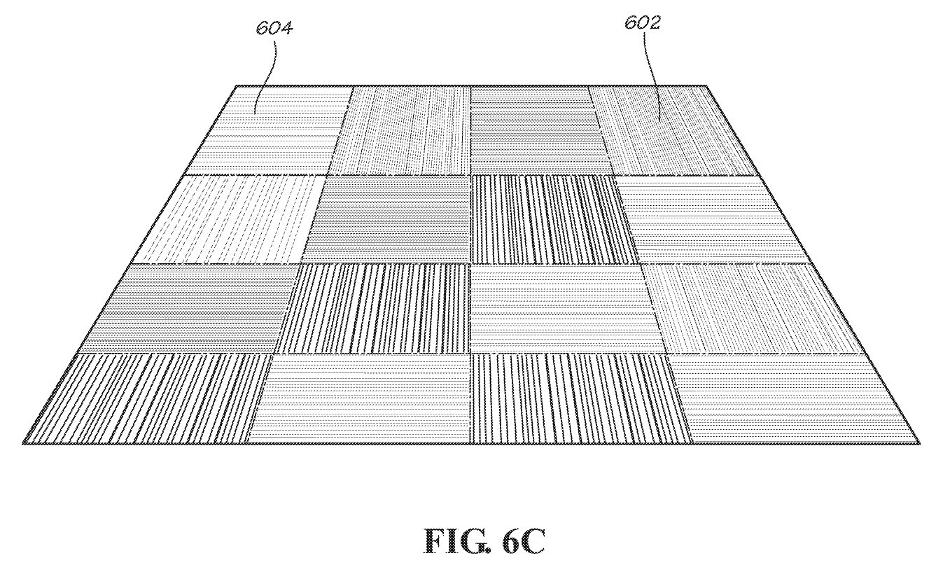

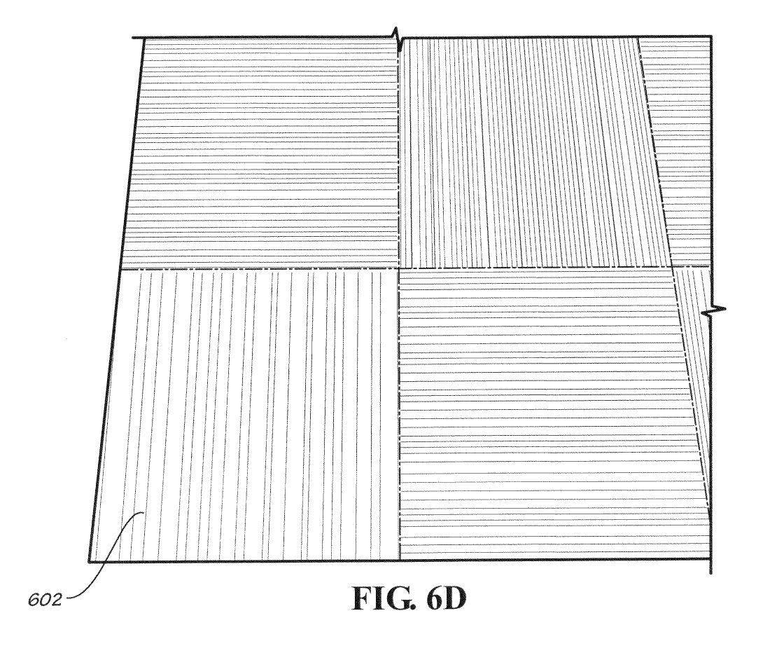

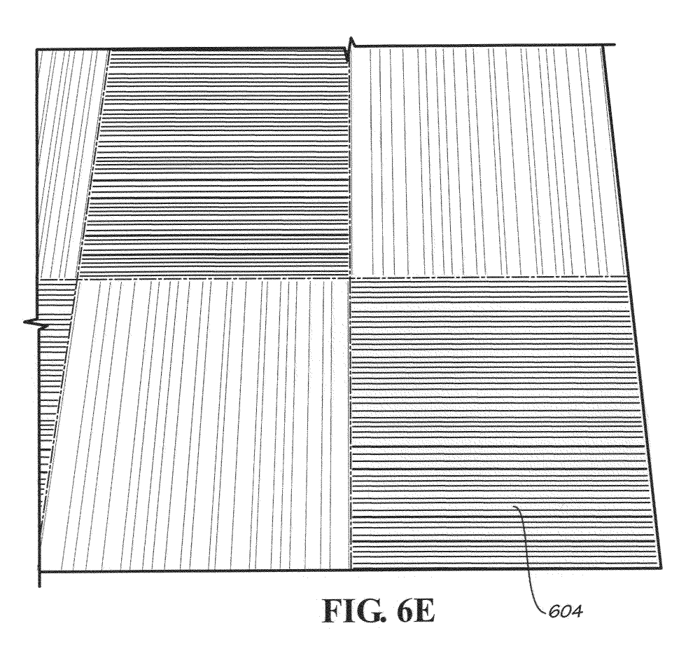

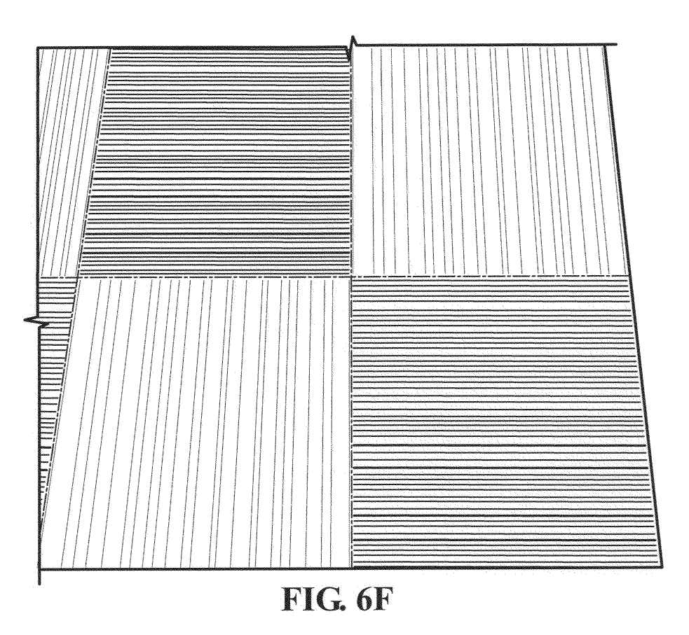

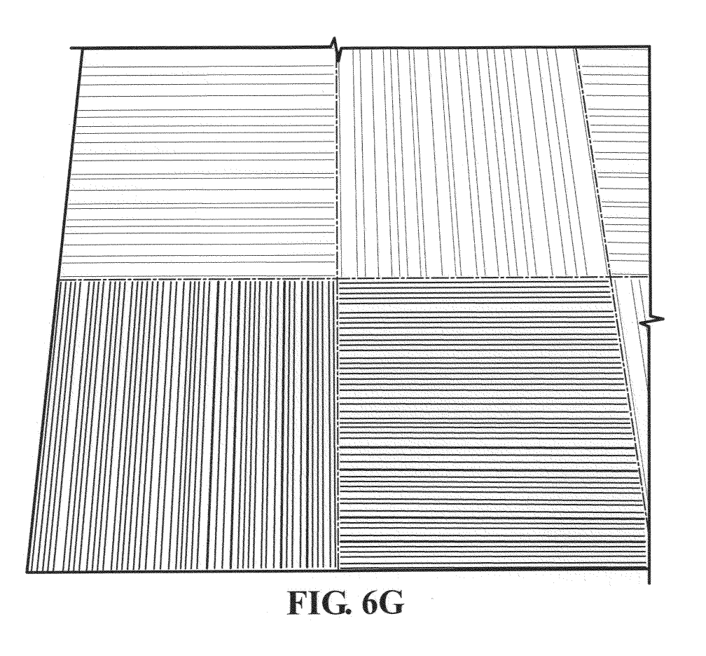

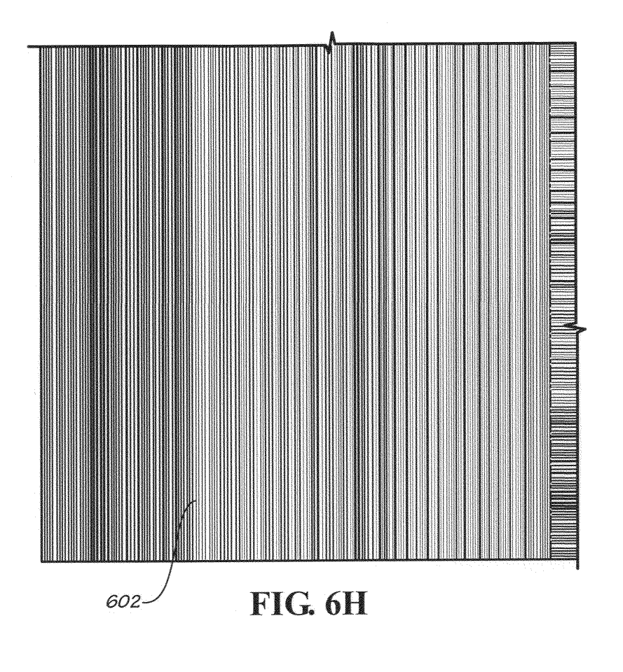

FIGS. 6A-6H are images of other installations of carpet tiles produced with diversity of color and texture according to still other embodiments. As illustrated in FIG. 6A, carpet tile 602 includes more of the lighter color yarns than carpet tile 604, while carpet tile 604 includes more of the darker color yarns than carpet tile 602.

Also provided are methods of producing a pattern on a tufting machine. The tufting machine tufts a web having a pattern of color and texture. The web pattern may repeat along the length of the web such that many carpet tiles may ultimately be cut down length of the web after secondary backings are attached. In one exemplary embodiment, an attribute of yarn color is varied across the width of the web pattern. For example, the web pattern may use six yarn colors. One side of the web may include a higher percentage of light color yarns than the other side of the web. As a specific example, the amount of lighter yarns in the pattern may increase from left to right while the amount of darker yarns decreases from right to left across the pattern. Other color features in the alternative or addition can be varied throughout or across the web pattern, including but not limited to color hue, color value, and/or color saturation, to enhance the appearance of color differences throughout or across the web. In another embodiment, the web pattern includes differences in pile height down the length of the web to create differences in texture from tile to tile.

Generally, the diversity of color, texture, and/or other features of carpet tiles formed from these exemplary carpet webs may provide one or more of the various benefits discussed above and other benefits recognized by those of skill in carpet tile design and manufacture. In some circumstances, for example, it may be desirable for carpet tiles to mimic the appearance of features of natural elements. As a specific example, it may be desirable for carpet tiles to mimic the randomness of wood grain to give an appearance similar to a wood flooring surface. In other circumstances, the use of diversity of color, texture, and/or other features disclosed herein allow carpet tiles to mimic differences that might otherwise exist with respect to yarn dye lot differences, making a carpet tile style better suited for selective replacement by tiles that are not made using the same yarn dye lots. Similarly, the effect of wear on the carpet tiles may be less noticeable given the diversity in the carpet tile style and differences in wear (e.g., between hallways and corners) may be less noticeable. The patterns disclosed herein and produced using the features and design principles discussed herein are generally not “orthogonally ambiguous” as that term is used in U.S. Pat. No. 6,908,656 (entitled “Orthogonally ambiguous carpet tile,” filed Feb. 14, 2001) and U.S. Pat. No. 7,083,841 (entitled “Orthogonally ambiguous carpet tiles having curved elements,” filed Jun. 7, 2002), both to David Oakey and Sydney Daniel.

The disclosed embodiments are merely illustrative. In short, the techniques and the other features described herein have uses in a variety of contexts, not to be limited by the specific illustrations provided herein. It should also be noted that embodiments may comprise different patterns and methods than those disclosed herein. The features shown are merely illustrative and are not intended to indicate that any component, feature, or method step is essential or necessary to any embodiment or limiting the scope of the present disclosure. The foregoing description of the embodiments has been presented only for the purpose of illustration and description and is not intended to be exhaustive or to limit the disclosure to the precise forms disclosed. Numerous modifications and adaptations are apparent to those skilled in the art without departing from the spirit and scope of the disclosure.

1. A carpet web created for manufacturing carpet tiles, the carpet web comprising:
a width of the carpet web corresponding generally to a width of a tufting machine used to create the carpet web; and
a length of the carpet web corresponding to a direction of tufting by the tufting machine such that yarns are generally tufted in the direction of tufting to form a textile face,
wherein the textile face comprises texture that varies such that carpet tiles cut from a first position along the width or length have more texture than carpet tiles cut from a second position along the width or length, wherein a carpet tile has more texture than another carpet tile if it includes a greater difference between its highest and lowest tufts.

2. The carpet web of claim 1, wherein the texture varies along the length of the carpet web such that carpet tiles cut from the first position, the second position, a third position, and a fourth position along the length of the carpet web are each different with respect to texture than one another.

3. The carpet web of claim 1, wherein:
the carpet tiles cut from the first position along the length of the carpet web have more texture than carpet tiles cut from the second position along the length of the carpet web;
the carpet tiles cut from the second position along the length of the carpet web have more texture than carpet tiles cut from a third position along the length of the carpet web; and
the carpet tiles cut from the third position along the length of the carpet web have more texture than carpet tiles cut from a fourth position along the length of the carpet web.

4. The carpet web of claim 3 wherein the first position is adjacent the second position, the second position is adjacent the third position, and the third position is adjacent the fourth position along the length of the carpet web.

5. A carpet web created for manufacturing carpet tiles, the carpet web comprising yarns that together form a textile face, the textile face comprising:
a color attribute that varies along a first dimension of the carpet web such that carpet tiles cut from a first position along the first dimension are different with respect to the color attribute than carpet tiles cut from a second position, different from the first position, along the first dimension; and
texture that varies along a second dimension of the carpet web such that the texture in carpet tiles cut from a first portion along the second dimension have more texture than carpet tiles cut from a second portion along the second dimension, wherein a carpet tile has more texture than another carpet tile if it includes a greater difference between highest and lowest tufts; and
wherein the first dimension of the carpet web is substantially orthogonal to the second dimension of the carpet web.

6. The carpet web of claim 5, wherein the color attribute relates to color lightness and color darkness, wherein the carpet tiles cut from the first position along the first dimension have a higher percentage of lighter yarns than carpet tiles cut from the second position along the first dimension.

7. The carpet web of claim 5, wherein the color attribute varies across the first dimension of the carpet web such that carpet tiles cut from the first position, the second position, a third position, and a fourth position along the first dimension are each different with respect to the color attribute than one another.

8. The carpet web of claim 5, wherein the color attribute relates to color lightness and color darkness, wherein:
the carpet tiles cut from the first position along the first dimension have a higher percentage of lighter yarns than carpet tiles cut from the second position along the first dimension;
the carpet tiles cut from the second position along the first dimension have a higher percentage of lighter yarns than carpet tiles cut from a third position along the first dimension; and
the carpet tiles cut from the third position along the first dimension have a higher percentage of lighter yarns than carpet tiles cut from a fourth position along the first dimension;
wherein the first position is adjacent the second position, the second position is adjacent the third position, and the third position is adjacent the fourth position.

9. The carpet web of claim 5 wherein:
the first dimension is a width of the carpet web corresponding to a width of a tufting machine used to create the carpet web; and
the second dimension is a length of the carpet web corresponding to a direction of tufting by the tufting machine such that the yarns are generally tufted in the direction of tufting by the tufting machine.

10. The carpet web of claim 5, wherein the color attribute is color hue or color saturation.

11. The carpet web of claim 5, wherein the yarns comprises yarns of six different colors.

12. The carpet web of claim 5, wherein the textile face comprises at least three different yarn pile heights.

13. A plurality of carpet tiles cut from a carpet web, each of the plurality of carpet tiles comprising a color attribute,
wherein a second color attribute of a second set of carpet tiles cut from a second column of the carpet web is greater than a first color attribute of a first set of carpet tiles cut from a first column of the carpet web, and
wherein a third color attribute of a third set of carpet tiles cut from a third column of the carpet web is greater than the second color attribute of the carpet tiles cut from the second column of the carpet web, and
wherein the first column is adjacent the second column and the second column is adjacent the third column across a width of the carpet web corresponding generally to a width of a tufting machine used to create the carpet web.

14. The plurality of carpet tiles of claim 13, wherein each of the plurality of carpet tiles comprises a plurality of lighter colored yarns and darker colored yarns, and wherein the first set of carpet tiles comprises a higher percentage of lighter colored yarns than the second set of carpet tiles, and the second set of carpet tiles comprises a higher percentage of lighter colored yarns than the third set of carpet tiles.

15. The plurality of carpet tiles of claim 13, wherein each of the plurality of carpet tiles comprises a plurality of lighter colored yarns and darker colored yarns, and wherein the first set of carpet tiles comprises a higher percentage of lighter colored yarns than the second set of carpet tiles, and the third set of carpet tiles comprises a higher percentage of lighter colored yarns than the second set of carpet tiles.

16. The plurality of carpet tiles of claim 13, wherein the carpet tiles comprise different textures, wherein a carpet tile has more texture than another carpet tile if it includes a greater difference between its highest and lowest tufts.

17. Carpet tiles cut from a carpet web, the carpet tile comprising:
a first set of carpet tiles that comprise tufts of a low pile height and tufts of a medium pile height;
a second set of carpet tiles that comprise tufts of the medium pile height and a high pile height, wherein the second set of carpet tiles is substantially free of tufts having the low pile height.

18. The carpet tiles of claim 17 wherein the first set of carpet tiles are from a first position along a width of the carpet web and the second set of carpet tiles are from a second position, different from the first position, along the width of the carpet web.

19. The carpet tiles of claim 17 further comprising:
a third set of carpet tiles that comprise tufts of the low pile height and the high pile height, wherein the third set of carpet tiles is substantially free of yarns having the medium pile height.

20. The carpet tiles of claim 19 wherein the first, second, and third sets of carpet tiles are from different positions along a width of the carpet web.
